(19) United States
(12) Patent Application Publication
(10) Pub. No.: US 2015/0167960 A1
(43) Pub. Date: Jun. 18, 2015

(54) METHOD OF APPLYING A PROTECTIVE CLADDING, PARTICULARLY TO GAS-TIGHT MEMBRANES OF ENERGY BOILERS

(71) Applicant: PLASMA SYSTEM S.A., Siemianowice Slaskie (PL)

(72) Inventors: Aleksander Borek, Katowice (PL); Andrzej Klimpel, Gliwice (PL)

(73) Assignee: PLASMA SYSTEM S.A., Siemianowice Slaskie (PL)

(21) Appl. No.: 14/404,593

(22) PCT Filed: May 29, 2013
(86) PCT No.: PCT/PL2013/000070

§ 371 Date: Nov. 28, 2014

(30) Foreign Application Priority Data
May 30, 2012 (PL) P.399378

(51) Int. Cl. F22B 37/10; B08B 17/00

(52) U.S. Cl. CPC F22B 37/108; B08B 17/00

(57) ABSTRACT

A method of applying a protective cladding, particularly to gas-tight membranes of energy boilers involves coupling of two gas-tight membranes (2) together, and then soaking a pair of gas-tight membranes (2) coupled together at 300° C. to 800° C., favorably at around 700° C.; afterwards, the membrane (2) surface where a cladding (1) is to be applied is cleaned, a pair of gas-tight membranes (2) coupled together is mounted on a positioner and then preheated up to 80° C. to 600° C., favorably to around 300° C.-450° C., and then the cleaned and preheated surface of a pair of gas-tight membranes (2) coupled together is covered with a protective cladding (1), wherein a protective cladding is applied at a thickness of 0.1 mm to 3.00 mm, favorably around 0.6 mm, and then the entire pair of gas-tight membranes (2) coupled together with a cladding (2) is finally soaked at 300° C. to 800° C., favorably at around 700° C., and the set temperature is maintained for 10 minutes to 600 minutes, favorably for 15 minutes to 30 minutes, and finally, gas-tight membranes (2) with a cladding are uncoupled.

The present invention refers to a method of applying a protective cladding to gas-tight membranes of energy boilers.

Environmental regulations, especially in the context of NOx emissions reduction, make it necessary to use new methods of coal combustion in pulverized fuel boilers. Low-emission combustion, injection of ammonia into a combustion chamber, addition of biomass for combustion lead to strong corrosion of evaporator walls (membrane). An alternative is to use expensive off-gas catalysts. It is possible to protect membranes against corrosion by application of anti-corrosion protective coatings or by use of air shrouds.

There is known from Polish patent description, PL 200773, a method of applying an anti-corrosion coating to heating walls of combustion chambers, which consists in blast cleaning of the substrate up to cleanliness Sa 3 and roughness Rz from 35 μm to 100 μm, wherein in the second phase pulverized aluminum is plasma sprayed, and in the third phase the surface layer of the coating is reinforced thermally until Al₂O₃ is obtained.

Use of an air shroud does not fully separate membranes from the aggressive atmosphere inside a combustion chamber; furthermore, this solution is expensive and its maintenance is costly. It is also difficult to control the flow rate of air used as a shroud, and to control the air intake for the combustion process at the same time. Significant amount of heat introduced via a conventional welding process (TIG, MIG/MAG or submerged arc welding) results in significant tension and deformation to membranes in the process of cladding application, and a cladding layer has a thickness of much above 1 mm which results in the consumption of a significant amount of an expensive material.

A method according to the invention is to eliminate drawbacks of the known solutions, and in this way make it possible to achieve a thin gas-tight protective cladding attached permanently (metallurgically) to the substrate, characterized by a very long useful life, especially in the conditions of low-oxygen corrosion.

A method according to the invention involves coupling of two gas-tight membranes together, and then soaking a pair of gas-tight membranes coupled together at 300° C. to 800° C., favorably at around 700° C.; afterwards, the membrane surface where a cladding is to be applied is cleaned, mounted on a positioner and then preheated up to 80° C. to 600° C., favorably to around 300° C.-450° C., and then the cleaned and preheated surface of a pair of gas-tight membranes coupled together is covered with a protective cladding, wherein a protective cladding is applied at a thickness of 0.1 mm to 3.00 mm, favorably around 0.6 mm, and then the entire pair of gas-tight membranes coupled together with a cladding is finally soaked at 300° C. to 800° C., favorably at around 700° C., and the set temperature is maintained for 10 minutes to 600 minutes, favorably for 15 minutes to 30 minutes, and then, gas-tight membranes with a cladding are uncoupled.

Gas-tight membranes are joined by welding metal sections onto their edges and/or flanges.

Surface of a gas-tight membrane is cleaned by laser ablation, with a laser beam having an exit power from 100 kW to 600 kW, favorably 300 kW, a spot diameter from 0.1 mm to 1.0 mm, favorably around 0.5 mm and a scanning width of 30 mm to 80 mm, favorably around 60 mm, a laser pulse frequency of 10000 per second to 50000 per second, favorably around 20000 pulses per second.

Preliminary soaking is performed by insertion of heaters in between flanges and pipes of a gas-tight membrane.

Preliminary soaking is performed by insertion of heaters in between flanges and pipes of a gas-tight membrane and/or into membrane pipes.

For cladding of a gas-tight membrane, a material in the form of powder or wire is used, having the following composition: nickel from 50% to 80%, favorably around 66%, chromium from 8.0% to 50.0%, favorably around 20.0%, boron from 0.1% to 5.0%, favorably around 0.85%, silicon from 0.08% to 6.0%, favorably around 1.2%, manganese from 0.05% to 1.8%, favorably around 0.15%, molybdenum from 2.0% to 12.0%, favorably around 6.8%, niobium from 1.2% to 4.0%, favorably around 2.7%, iron from 0.01% to 4.0%, favorably around 1.8%, carbon from 0.03% to 0.9%, favorably around 0.25%.

For cladding of a gas-tight membrane a material in the form of powder or wire is used, having the following composition: nickel from 50% to 80%, favorably around 64.0%, chromium from 8.0% to 50.0%, favorably around 22.0%, silicon from 0.08% to 1.0%, favorably around 0.25%, manganese from 0.05% to 2.0%, favorably around 0.20%, molybdenum from 2.0% to 15.0%, favorably around 9.0%, niobium from 2.0% to 5.0%, favorably around 3.6%, carbon from 0.01% to 0.5%, favorably around 0.03%, iron favorably below 1.0%.

For cladding of a gas-tight membrane, a material in the form of powder or wire is used, having the following composition: nickel from 60.0% to 80.0%, favorably around 70.4%, chromium from 8.0% to 20.0%, favorably around 17.3%, silicon from 2.0% to 7.0%, favorably around 4.0%, boron from 2.0% to 6.0%, favorably around 3.43%, carbon from 0.4% to 2.0%, favorably around 0.89%, iron from 2.5% to 7.0%, favorably around 4.0%.

For application of a protective cladding to a gas-tight membrane laser beam radiation energy is used.

Cold Metal Transfer (CMT) technology is used for application of a protective cladding to a gas-tight membrane.

In the process of cladding application, source power (laser, CMT) is controlled by a pyrometer or an infrared camera in such a way that a temperature of a cladding layer never exceeds 2600° C., and favorably is 2300° C. to 2500° C.

Protective cladding parameters are controlled in such a way that the process running area is supplied with energy of 2.5-12 kJ/g of feedstock, favorably 4-6 kJ/g.

The amount of energy fed to the cladding area is determined so as to have heat penetration to a substrate in the cladding area below 2.00 mm, and favorably below 0.2 mm.

Cladding is applied to a pair of gas-tight membranes coupled together, mounted on a positioner in such a way that after one or more beads are applied to one side of a pair of gas-tight membranes coupled together, this pair is turned and one or more beads are applied to another side of a pair of gas-tight membranes, wherein the cycle is repeated until the entire protective layer is applied as planned.

One cycle comprises application of at least one bead over a length no lower than 0.4 of a gas tight membrane's length to one side of a pair of gas-tight membranes coupled together; favorably a cladding is applied to 5%-10% of the planned surface. Protective cladding is applied simultaneously to opposite sides of a pair of gas-tight membranes coupled together.

Protective cladding is applied in a weave patter using CMT technique characterized by the following parameters: frequency of 1 Hz to 3 Hz, favorably 2 Hz, amount of cladding applied from 3.0 kg per hour to 6.0 kg per hour, favorably 4.3 kg per hour, weave amplitude from 10 mm to 12 mm.

For connection of gas tight membrane flanges by metal sections, continuous or stitch welding is used.

A coupled pair of gas-tight membranes is preheated before cladding application and/or in the process of cladding application up to a temperature of 80° C. to 600° C., favorably 300° C. to 450° C.

Adjacent pipe ends of gas-tight membranes are welded together.

Gas-tight membranes are coupled with bolts and/or sections located along membrane edges.

Surface of a gas-tight membrane is blast cleaned up to a cleanliness level of Sa3, using corundum and/or shot of a fraction from 0.5 mm to 2.0 mm, favorably around 0.7 mm, and applying gas pressure from 2.5 bar to 12.0 bar, favorably around 7.0 bar.

A fixed distance between a cladding head and a coupled pair of membranes is maintained by a laser tracing system.

One end of a positioner can move freely along the longitudinal axis of a membrane. A method according to the invention makes it possible to apply a permanent gas-tight cladding to a gas-tight membrane composed of several pipes and beams welded together, by applying a cladding of material resistant to aggressive environment inside a combustion chamber of a boiler fired by waste or coal or coal mixed with biomass or another bioorganic substance.

Composition of a protective cladding guarantees resistance to low-oxygen (high temperature) corrosion caused by sulfur and chlorine compounds, and to ammonia-based corrosion.

This protection is offered by nickel and chromium based mixtures. Iron content should be minimized.

Due to the application of solutions such as a “cold vortex”, a protective cladding should be more erosion-resistant than boiler steel.

To improve erosion-resistance properties, nickel and chromium based material can be enriched with manganese, molybdenum, niobium and silicon, and boron, the presence of which improves fusibility of the mixture, and makes a cladding layer harder.

Application of a metallic protective cladding which is permanently attached to a steel substrate is commonly used in industry, with the use of conventional welding technologies such as TIG, MIG/MAG, submerged arc.

Application of traditional welding technologies requires introduction of significant heat amounts, which result in significant heat penetration layer in a substrate, making significant heat amount permeate an element, which leads to increased stresses, and eventually significant deformation of an element.

Traditional cladding processes do not make it possible to obtain thin protective layers of 0.2 mm-1 mm.

When beams and pipes are welded into gas-tight membranes, thermal stress is generated inside an element.

Cladding processes do also lead to thermal stress on the surface of an element, which makes it bend to the “inside” towards the cladding.

Preheating of an element removes stresses generated in the process of a gas-tight membrane welding.

Coupling of 2 membranes with each other makes cladding stresses on both sides of such membranes coupled together set off, which eliminates a deformation of a coupled pair of membranes.

While placing an element on a positioner having a horizontal axis, cladding can be applied alternately. In a method according to the invention, several beads are applied to one side of a pair of membranes coupled together, then this pair is turned, and cladding is applied to another side. The cycle is repeated multiple times so that stresses generated on one side are shortly compensated by cladding on another side. Vertical positioning of membranes when using two devices makes it possible to apply a cladding layer to both sides at the same time and to compensate thermal stresses on an ongoing basis, and to maintain the shape.

A protective cladding must be resistant to chemical impact from the atmosphere inside a boiler, it should be entirely gas-tight and permanently attached to the substrate, any possible pores should be closed. These conditions, contrary to thermally sprayed coatings, can be fulfilled by claddings.

Traditional cladding techniques, TIG, MIG/MAG, submerged arc technique introduce significant amounts of heat into an element leading to local temperatures of 2800° C., which leads to large stresses causing deformations, and a deep heat penetration zone of over 1 mm. These processes are difficult to be precisely controlled and do not make it possible to obtain thin layers of 0.3 mm-0.7 mm which would reduce the consumption of expensive material and minimize introduction of significant heat amounts into an element.

Application of laser cladding technologies combined with temperature control systems and laser power control on the basis of cladding temperature makes it possible to precisely control cladding temperature in the process of its application and to maintain this temperature below a boiling point of main feedstock ingredients, which facilitates process stability and makes it possible to obtain a high quality cladding.

Correspondingly, the use of Cold Metal Transfer (CMT) technology for cladding application minimizes the volume of heat introduced into an element, resultant stresses and heat penetration zone.

Element preheating before and during the cladding application process, up to several hundred degrees, makes it possible to reduce the cooling rate of a cladding which as a consequence prevents cracks and integrity losses in a cladding.

Excessive cooling rate of a cladding and cracking thereof are prevented also by the use of cladding in a weave pattern while using CMT technology.

Continuous preheating of an element while cladding application results in favorable reduction of stresses therein.

To eliminate residual stresses after a cladding process, a pair of membranes coupled together is soaked at a temperature of several hundred degrees, favorably around 700° C. for several dozen minutes.

Initial deformation of membranes in the direction opposite to the stresses generated during cladding application makes residual stresses remaining after relief soaking process compensate with elastic stresses caused by membrane deformation, which leads to membrane unbending.

Thanks to initial deformation of a membrane, its possible unbending after cladding process propagates in such a direction that while unbending a protective cladding is not stretched which eliminates a risk of crack formation.

Use of a laser tracing system mounted on a robot arm makes it possible to keep a constant distance from a membrane in case a pair of membranes coupled together has been initially deformed by spacers before cladding application, which facilitates the programming of the entire process.

To compensate for length changes due to temperature fluctuations while preheating before and cladding application to a coupled pair of membranes, one end of a positioner can move freely move freely along the longitudinal axis of pipes.

An advantage of a method according to the invention is that membrane deformations are minimized thanks to coupling the membranes together and relieving stress by soaking, which reduces stresses leading then to deformations of pipes, flanges and welded joints while laser cladding application; an advantage of a method is also a possibility to have a cladding fully tight as it is metallurgically bonded with a substrate layer.

An advantage of a method according to the invention is the use of a thermal stress compensation phenomenon, which is obtained thanks to membrane coupling.

Soaking and preheating before cladding application removes gases trapped in the surface structure of a membrane.

Initial deformation of gas-tight membranes reduces a risk of cracks on a protective cladding after membranes are uncoupled.

Initial deformation minimizes a requirement to unbend membranes after uncoupling. Final soaking after cladding application eliminates stresses and minimizes deformations of membranes after their uncoupling.

The present invention is shown as an embodiment in a drawing where

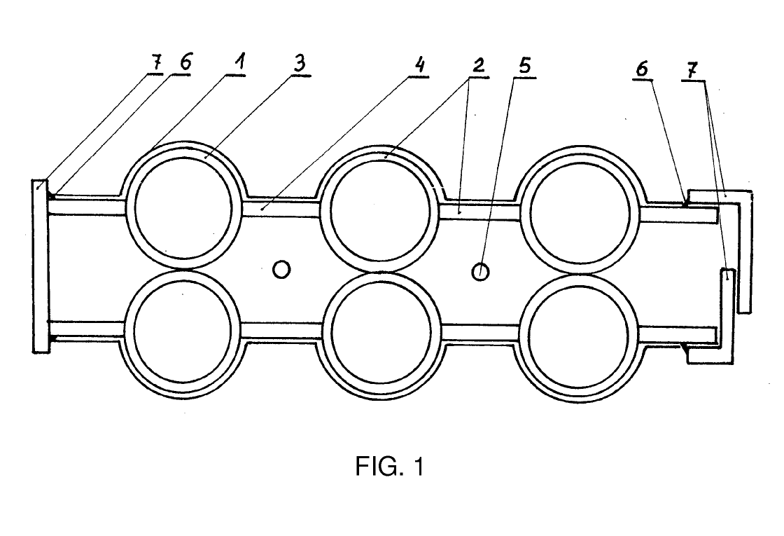

FIG. 1 shows a view of a pair of gas-tight membranes coupled together from the side of pipes inlet with heaters inserted in between pipes and flanges,

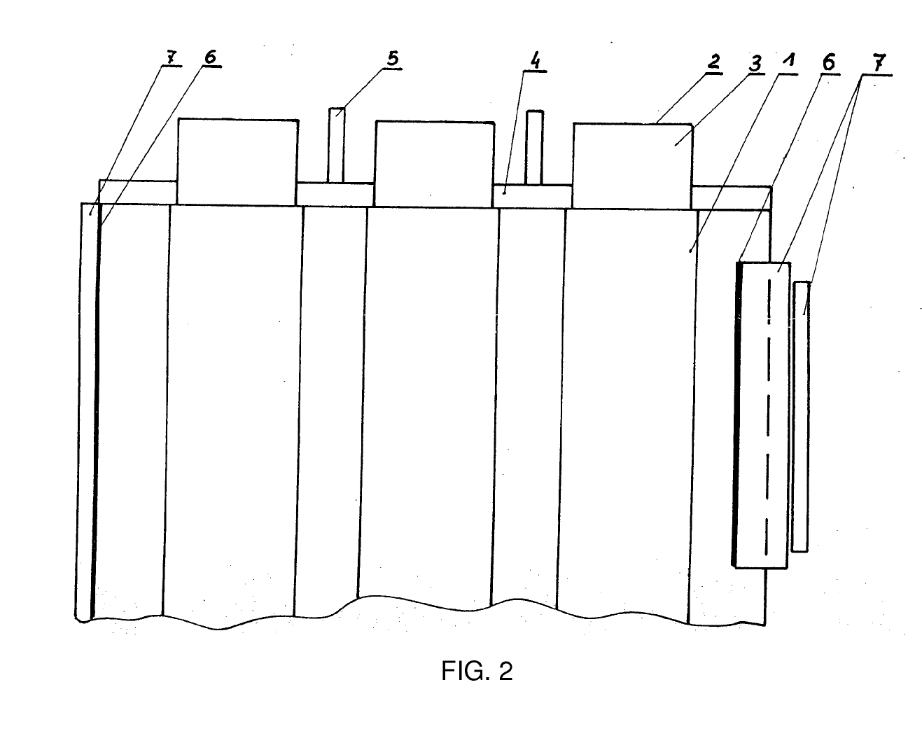

FIG. 2 shows a top view of a pair of gas-tight membranes coupled together,

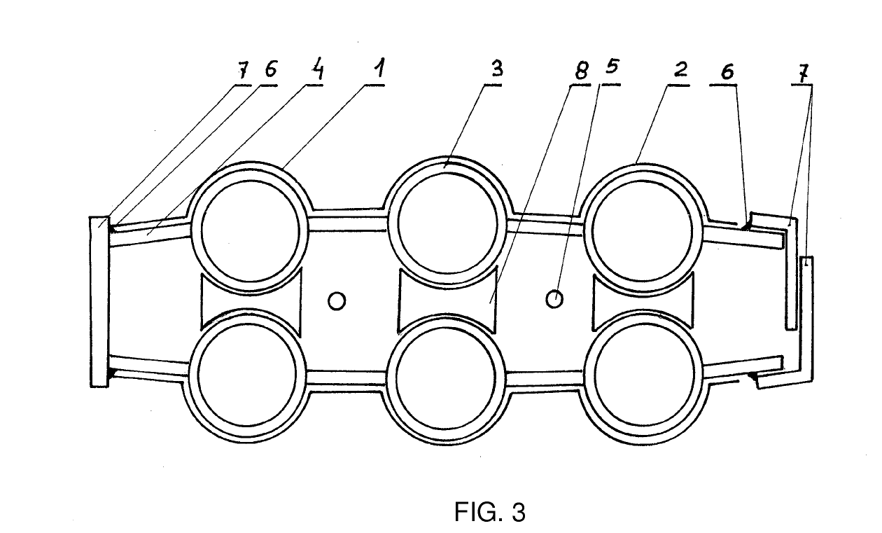

FIG. 3 shows a view of a pair of gas-tight membranes coupled together from the side of pipes inlet after insertion of distance spacers,

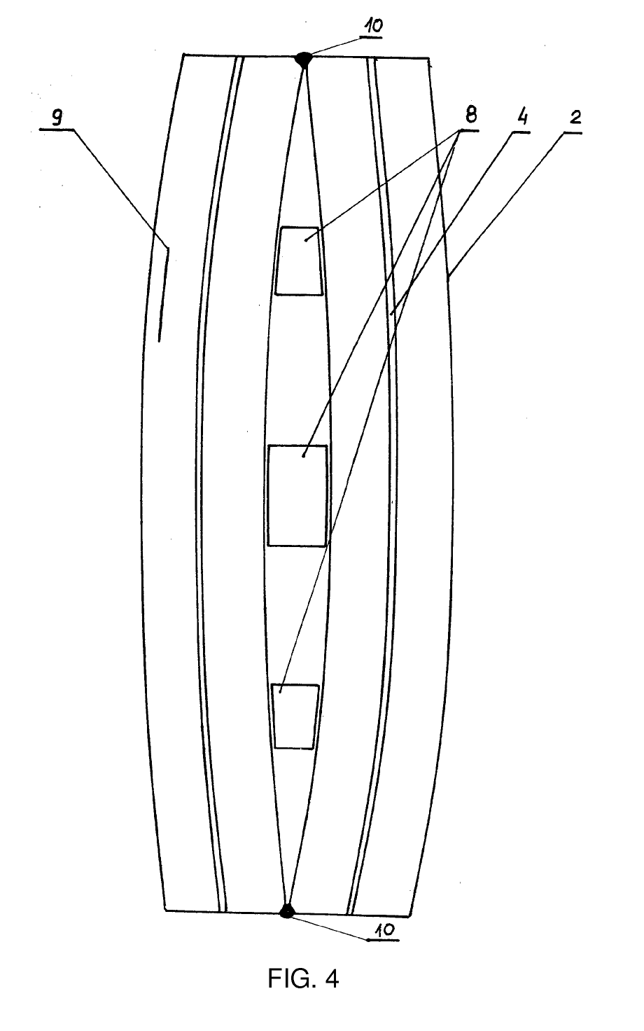

FIG. 4 shows a side view of a pair of gas-tight membranes coupled together after insertion of distance spacers,

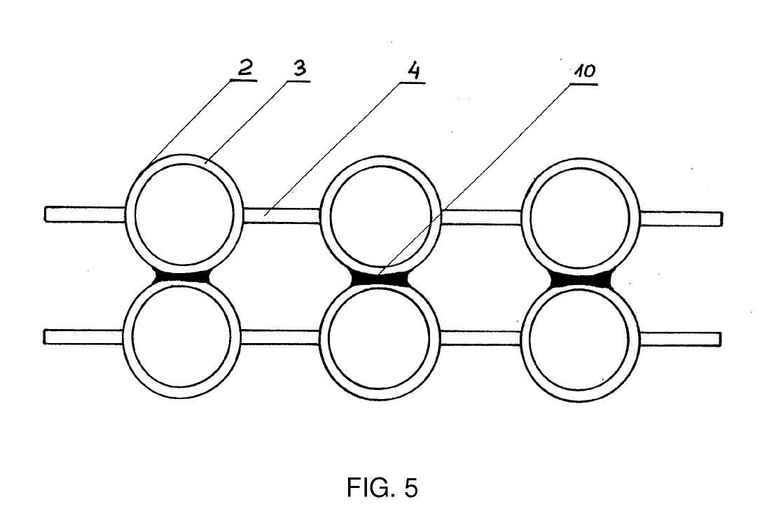

FIG. 5 shows a view of a pair of gas-tight membranes coupled together connected by weld joints, shown from the side of pipes,

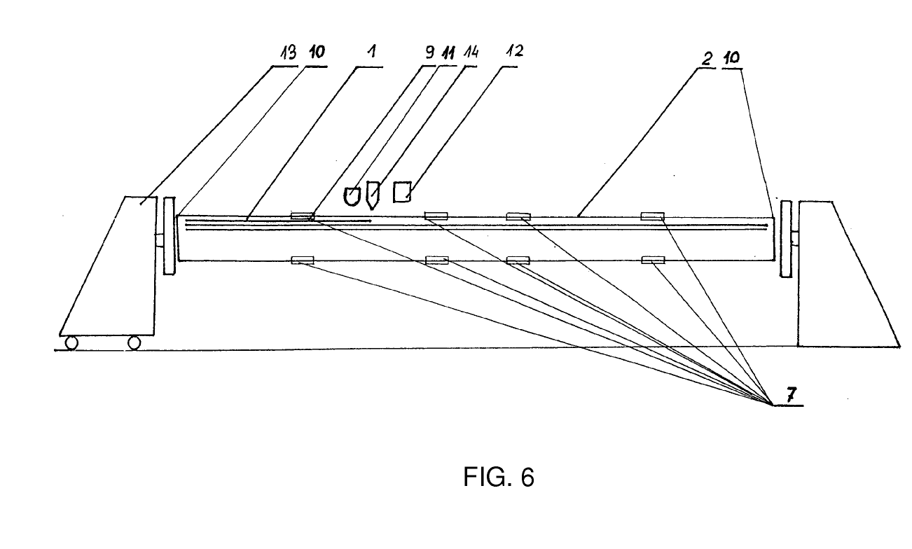

FIG. 6 shows a view of a pair of gas-tight membranes coupled together in a vertical position as mounted on a positioner, and

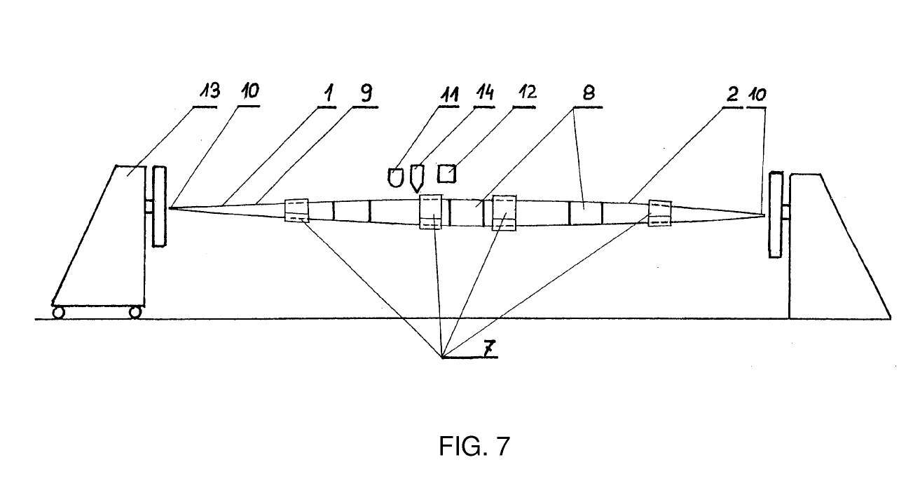

FIG. 7 shows a view of a pair of gas-tight membranes coupled together in a horizontal position as mounted on a positioner.

One embodiment of the invention is a process of applying a protective cladding (1) to a surface of a pair of gas-tight membranes (2) coupled together, around 6 m long, 425 mm wide and composed of five pipes (3) of a diameter of around 61 mm joined by flanges (2), around 20 mm wide, and ending with flanges, around 20 mm wide. Two gas-tight membranes (2) having the same dimensions were coupled together in such a way that angle (7) sections were fastened by a weld (6) to their edge flanges, said angles provided with slits; afterwards, one membrane was laid horizontally, and spacers (8) having different thicknesses and shape corresponding to the shape of pipes (3) were put onto it in such a way that the thickest spacer, 20 mm thick, was put in the center of the middle pipe, and that thinner spacers were laid in the direction of a membrane edge. After such preparation of one membrane, another one was laid onto it; membrane edges over entire circumference were drawn to each other by a vice. Contacting pipes at membrane edges were joined together by a weld (10), and bolts were put inside angle slits and tightened so that a pair of membranes coupled together became slightly convex. A pair of membranes coupled together was soaked in an oven for 20 minutes at a temperature of 700° C., wherein both sides were shot blasted up to Sa3 level, using corundum of a grain size 0.5 mm to 0.8 mm at an air pressure of around 7.0 bar. Then, a pair of gas tight membranes (2) coupled together was mounted on a horizontal positioner (13) making it possible to turn the gas-tight membranes coupled together around the longitudinal axis of this pair, where both sides of the positioner were provided with 8 m long travel ways, where two robots were moving. Positioner's (13) design makes it possible to compensate changing lengths of a pair of gas tight membranes (2) resulting from changeable temperatures during preheating and applying a protective cladding (1) with a laser. Robots are provided with heads (14) for application of a cladding by a laser; these heads are connected with infrared cameras (11) and laser tracing systems (12) making it possible to keep a constant distance from membrane surface. Heads are connected to optic fiber from lasers, 4 kW each. Infrared cameras (11) control laser power via software. In between flanges (4) and pipes (3) of membranes there are 4 electric heaters (5), 6 m long, which are connected to power supply units. For 2.5 hours of membranes heating in a horizontal position, they reached a temperature of 300° C. After the set temperature was achieved, cladding application process started, with feedstock chemistry corresponding to the chemistry of Inconel 625 commercial product; powder was fed at a rate of 30 g/min with laser power of 2.8 kW to 3.2 kW, at a linear speed of a head of 3600 mm/min. Single bead width (9)—4 mm, cladding height 0.5 mm-0.7 mm, bead lap ca. 2.0 mm. Distance from a head tip to the substrate—13 mm.

Inert gas flow rate 4-6 l/min, shroud gas (argon) flow rate 9 l/m. After application of cladding to 2 middle flanges and adjacent welds, the positioner turned a pair of membranes coupled together by 180 degrees and the process was repeated on another side. The cycle was repeated three times until the entire flange (4) surface was covered on both sides of a pair of membranes coupled together. Then, a similar method was used to apply a cladding to pipe top (3), around 30 degrees to each side on all pipes. Then, a pair of membranes was turned by 90 degrees and, when in a vertical position, cladding was applied to exposed top areas of all 5 pipes with the same parameters, and the process was run simultaneously on both sides of a pair of gas-tight membranes (2) coupled together. Then, membranes coupled together were turned by 180 degrees, and cladding was applied simultaneously to the remaining exposed pipe areas, one by one, using the same parameters. During the entire process, heaters located in between pipes and flanges kept a temperature of the membranes beyond the cladding zone at a level of around 300° C. After process completion and membrane cooling, a pair of membranes coupled together was removed from a positioner and soaked in an oven to relieve stresses, with a temperature of 700° C. maintained for 30 minutes. Finally, pipe ends welded together with the membranes were cut through, bolts connecting sections (angles) (7) welded onto the flanges were removed and sections (7) were cut off from the membranes. While uncoupling, membranes deformed slightly towards the surface covered with a protective cladding, thus achieving the shape making possible to fit them into a boiler.

1. A method of applying a protective cladding, particularly to gas-tight membranes of energy boilers, characterized in that two gas-tight membranes are coupled together, and then a resultant pair of gas-tight membranes is soaked at 300° C. to 800° C., favorably at around 700° C., wherein a surface of a gas-tight membrane where a protective cladding will be applied is cleaned, mounted on a positioner and then preheated to 80° C. to 600° C., favorably to around 300° C.-450° C., and then the cleaned and preheated surface of a pair of gas-tight membranes coupled together is covered with a protective cladding, wherein a protective cladding is applied at a thickness of 0.1 mm to 3.00 mm, favorably around 0.6 mm, and then the entire pair of gas-tight membranes coupled together with a cladding is finally soaked at 300° C. to 800° C., favorably at around 700° C., and the set temperature is maintained for 10 minutes to 600 minutes, favorably for 15 minutes to 30 minutes, and then, gas-tight membranes with a cladding are uncoupled.

2. A method according to claim 1 characterized in that gas-tight membranes are coupled by welding metal sections to their edges and/or flanges.

3. A method according to claim 1 characterized in that a surface of a gas-tight membrane is cleaned by laser ablation, with a laser beam having an exit power from 100 kW to 600 kW, favorably 300 kW, a spot diameter from 0.1 mm to 1.0 mm, favorably around 0.5 mm and a scanning width of 30 mm to 80 mm, favorably around 60 mm, a laser pulse frequency of 10000 per second to 50000 per second, favorably around 20000 pulses per second.

4. A method according to claim 1 characterized in that initial soaking is performed by insertion of heaters in between flanges and pipes of a gas-tight membrane.

5. A method according to claim 1 characterized in that initial soaking is performed by insertion of heaters in between flanges and pipes of a gas-tight membrane and/or inside pipes of a gas-tight membrane.

6. A method according to claim 1 characterized in that a protective cladding is applied to a gas-tight membrane in the form powder or wire feedstock having the following composition: nickel from 50% to 80%, favorably around 66%, chromium from 8.0% to 50.0%, favorably around 20.0%, boron from 0.1% to 5.0%, favorably around 0.85%, silicon from 0.08% to 6.0%, favorably around 1.2%, manganese from 0.05% to 1.8%, favorably around 0.15%, molybdenum from 2.0% to 12.0%, favorably around 6.8%, niobium from 1.2% to 4.0%, favorably around 2.7%, iron from 0.01% to 4.0%, favorably around 1.8%, carbon from 0.03% to 0.9%, favorably around 0.25%.

7. A method according to claim 1 characterized in that a protective cladding is applied to a gas-tight membrane in the form powder or wire feedstock having the following composition: nickel from 50% to 80%, favorably around 64.0%, chromium from 8.0% to 50.0%, favorably around 22.0%, silicon from 0.08% to 1.0%, favorably around 0.25%, manganese from 0.05% to 2.0%, favorably around 0.20%, molybdenum from 2.0% to 15.0%, favorably around 9.0%, niobium from 2.0% to 5.0%, favorably around 3.6%, carbon from 0.01% to 0.5%, favorably around 0.03%, iron favorably below 1.0%.

8. A method according to claim 1 characterized in that a protective cladding is applied to a gas-tight membrane in the form powder or wire feedstock having the following composition: nickel from 60% to 80%, favorably around 70.4%, chromium from 8.0% to 20.0%, favorably around 17.3%, silicon from 2.0% to 7.0%, favorably around 4.0%, boron from 2.0% to 6.0%, favorably around 3.43%, carbon from 0.4% to 2.0%, favorably around 0.89%, iron from 2.5% to 7.0%, favorably around 4.0%.

9. A method according to claim 1 characterized in that laser beam radiation energy is used for application of a protective cladding to a gas-tight membrane.

10. A method according to claim 1 characterized in that CMT technology is used for application of a protective cladding to a gas tight membrane.

11. A method according to claim 1, characterized in that parameters of a protective cladding application are controlled using the information from a pyrometer or an infrared camera in such a way that a cladding weld temperature while cladding application does not exceed 2600° C., and favorably amounts to 2300° C.-2500° C.

12. A method according to claim 1 characterized in that a protective cladding application parameters are controlled in such a way that the area of a cladding process is supplied with energy in the amount of 2.5-12 kJ per 1 g of feedstock, favorably 4-6 kJ/g.

13. A method according to claim 1 characterized in that the energy amount supplied to a protective cladding are is determined so as to have a heat penetration zone near the cladding weld below 2.0 mm, and favorably below 0.2 mm.

14. A method according to claim 1 characterized in that cladding is applied to a pair of gas-tight membranes coupled together mounted on a positioner alternately in such a way that one or several beads are applied to one side of a pair of gas-tight membranes coupled together, then this pair of gas-tight membranes coupled together is turned, and one to several beads are applied to another side of a pair of gas-tight membranes, wherein the cycle is repeated multiple times until the entire protective cladding is applied as planned.

15. A method according to claim 1 characterized in that during a single cycle at least one bead is applied over a length no lower than 0.4 of a gas tight membrane's length to one side of a pair of gas-tight membranes coupled together; favorably 5%-10% of the planned surface of a cladding is applied.

16. A method according to claim 1 characterized in that a protective cladding is applied simultaneously to opposite sides of a pair of gas-tight membranes coupled together.

17. A method according to claim 1 characterized in that a protective cladding is applied in a weave pattern using CMT technique characterized by the following parameters: frequency of 1 Hz to 3 Hz, favorably 2 Hz, amount of cladding applied from 3.0 kg per hour to 6.0 kg per hour, favorably 4.3 kg per hour, weave amplitude from 10 mm to 12 mm.

18. A method according to claim 1 characterized in that for connection of gas tight membrane flanges by metal sections, continuous or stitch welding is used.

19. A method according to claim 1 characterized in that initial and/or final soaking of a pair of gas-tight membranes coupled together is performed in an oven or a preheated box.

20. A method according to claim 1 characterized in that a pair of gas-tight membranes coupled together is preheated before and/or during cladding application up to 80° C. to 600° C., favorably to 300° C.-450° C.

21. A method according to claim 1 characterized in that gas-tight membranes coupled together are initially deformed while coupling by insertion of spacers in between the membranes coupled together, said spacers having variable thicknesses from 2 mm to 200 mm.

22. A method according to claim 1 characterized in that pipe ends of adjacent gas-tight membranes are connected by welds.

23. A method according to claim 1 characterized in that edges of adjacent gas-tight membranes are connected mechanically with bolts and/or sections.

24. A method according to claim 1 characterized in that a surface of a gas-tight membrane is shot blasted up to Sa3, using corundum and/or shot of a fraction from 0.5 mm to 2.0 mm, favorably around 0.7 mm, and applying gas pressure from 2.5 bar to 12.0 bar, favorably around 7.0 bar.

25. A method according to claim 1 characterized in that a fixed distance between a cladding head and a coupled pair of membranes is maintained by a laser tracing system.

26. A method according to claim 1 characterized in that one end of a positioner can move freely along the longitudinal axis of pipes.
